(19) United States
(12) Patent Application Publication
(10) Pub. No.: US 2006/0172247 A1
(43) Pub. Date: Aug. 3, 2006

(54) Orthodontic brackets coated to increase resistance to wear and deformation

(76) Inventors: Norbert Abels, Homburg (DE); Claus-H. Backes, Saarbrucken (DE)

Correspondence Address: RICK D. NYDEGGER;WORKMAN, NYDEGGER & SEELEY, 1000 Eagle Gate Tower, 60 East South Temple, Salt Lake City, UT, 84111, US

(21) Appl. No.: 11/045,948

(22) Filed: Jan. 28, 2005

(51) Int. Cl. A61C 3/00

(52) U.S. Cl. 433/8; 433/10

(57) ABSTRACT

An orthodontic bracket includes a protective coating material on the bracket surface to increase resistance to wear and deformation and/or to improve surface properties. The coating layer includes a cured resin chemically bonded to or cross-linked with a plurality of organically modified inorganic particles. The protective coating layer makes the surface of the bracket very hard and resistant to abrasion. The entire bracket, or any portion thereof, can be coated. For example, the arch wire slot and/or ligation cover can be coated since these portions of the bracket typically receive the greatest mechanical stress and/or abrasion. The coating material can be applied in very thin layers such as less than 10 microns, thereby minimizing the effect that the coating has, on the overall shape and size of the orthodontic bracket.

### BACKGROUND OF THE INVENTION

1. The Field of the Invention

The present invention relates to polymeric orthodontic brackets. More particularly the present invention relates to orthodontic brackets having a protective coating that improves the brackets' stability, smoothness, and resistance to wear or deformation.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth to correct underbites or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets, more particularly the orthodontic bases, are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the slot of each bracket. The arch wire acts as a template or track to guide movement of the teeth into proper alignment. End sections of the arch wire are typically captured within tiny appliances known as “buccal tubes” affixed to the patient's molars.

Once the arch wire is placed in the arch wire slot, the arch wire much be fastened to the bracket. Ligatures or some other form of fastening means are essential to ensure that the tensioned arch wire is properly positioned around the dental arch, and to prevent the wire from being dislodged from the bracket slots during chewing of food, brushing of teeth, or application of other forces.

There are two distinct methods for fastening the arch wire to the bracket. In brackets of the first type, small ligature wires or elastic bands are used to hold the arch wire in a securely seated position in the brackets. One type of commercially available ligature is a small, elastomeric O-ring, which is installed by stretching the O-ring around small wings known as “tie wings” that are on the bracket body. Metal ligatures are also used to retain arch wires within the bracket slots.

In an effort to simplify the process of installing braces, a second fastening method has been developed where the bracket is formed to be self-ligating. The term “self-ligating bracket” refers to a class of orthodontic brackets that include some sort of cover, whether separate from or hingedly or slidably attached to the base, which encloses or otherwise retains the arch wire within the slot of the base.

Traditionally orthodontic brackets were made from metals to withstand the forces involved in moving the teeth. Recent advancements in polymeric materials have allowed orthodontic brackets to be made from polymers. Polymeric materials provide many advantages over traditional brackets. For example, many self-ligating brackets are made from a polymeric material to form the ligation cover and allow the ligation cover to properly open and close.

Another advantage of polymeric materials is the ease with which the brackets can be manufactured. For example, some polymeric brackets are formed using injection molding techniques. Yet another advantage of polymeric materials is that they can be used to make brackets that are more aesthetically pleasing. For example, polymeric brackets can be made clear or opaque or made to better match the natural color of a person's teeth.

One disadvantage of some recently developed polymeric brackets is their lack of hardness and the ease with which they can be scratched or abraded. While new materials have made it possible to manufacture polymeric brackets, such brackets can be more likely to wear and/or deform than traditional brackets. For example, the arch wire slot of a polymeric bracket can become deformed or scratched by the arch wire in the arch wire slot. This deformation reduces the torque stability and accuracy of the alignments of the brackets and consequently can affect the straightness of the person's teeth. Ligation covers used with self-ligating brackets can also be deformed or worn down.

Thus, what is needed in the art is a polymeric orthodontic bracket that can better withstand abrasive and/or deformative forces exerted on orthodontic brackets thereby improving the bracket's wear, such as the wear caused by an arch wire.

### BRIEF SUMMARY

The present invention overcomes the abovementioned problems with orthodontic brackets by applying a protective resin coating on all or a portion of the orthodontic bracket. In an exemplary embodiment, the orthodontic brackets of the present invention are polymeric and include a base with a slot for receiving an arch wire. The base is configured to be bonded to a surface of a person's tooth.

In one embodiment, the orthodontic bracket is self ligating and includes a ligation cover for securing an arch wire in the arch wire slot. In an alternative embodiment, the orthodontic bracket has tie wings which allow a wire or elastic band to be placed thereon to secure the arch wire to the base.

The orthodontic brackets formed from a polymeric material can include materials such as polyamides (e.g., nylon), acetal polymers, polyetherimides, polycarbonates, polyarylether ketones, polysulfones, and polyphenylsulfones. In an exemplary embodiment, the polymeric material is injection molded to form the orthodontic bracket.

The protective resin can be coated on the arch wire slot or alternatively, where a ligation cover is used, the ligation cover can be coated. The protective coating can also be applied to at least a portion of the surface of the orthodontic bracket base or ligation cover.

The protective coating is formed from a curable resin that becomes chemically bonded (e.g., cross-linked) to a plurality of organically modified inorganic particles. The coating layer adheres very well to polymeric orthodontic brackets thereby reducing the tendency to crack or delaminate.

The coating layer is placed on the bracket at a preferred thickness of between about 0.1 micron to about 100 microns. More preferably the thickness of the coating layer is between about 0.5 micron to about 5 microns, and most preferably between about 1 micron to about 2 microns.

The coated polymeric brackets of the present invention exhibit surprisingly superior properties over polymeric brackets available in the prior art. Although the coating layer is very thin, the coating layer provides a durable protective layer that is able to make the surface of the treated orthodontic brackets very stiff such that the brackets resist wear and deformation. The coated surface increases the resistance to abrasive forces. In addition the brackets are better able to resist degradation due to saliva and heat. Surprisingly, these benefits are obtained with a very thin coating layer. Consequently, the coating can be applied without significantly affecting the shape and/or function of the polymeric bracket.

In addition to polymeric brackets, the protective resin coating can also be applied to increase or alter the smoothness, color or other surface qualities of brackets made of other materials such as metal or ceramic.

These and other advantages and features of the present invention will become more fully apparent from the following description and appended claims.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A illustrates a first exemplary self-ligating polymeric orthodontic bracket according to the present invention with an arch wire placed in the arch wire slot and the ligation cover in the open position;

FIG. 2B illustrates the orthodontic bracket of FIG. 1 with the ligation cover in the closed position;

FIG. 2A illustrates an alternative self-ligating orthodontic bracket according to the invention with an arch wire in the arch wire slot and the ligation cover in the open position;

FIG. 2B illustrates the orthodontic bracket of FIG. 2A with the ligation cover in the closed position;

FIG. 3A illustrates another exemplary orthodontic bracket according to the present invention with an arch wire placed in the arch wire slot; and

FIG. 3B illustrates the orthodontic bracket of FIG. 3A with an elastic ligature placed about the tie wings to secure the arch wire.

### DETAILED DESCRIPTION OF EXEMPLARY EMBODIMENTS

A detailed description of the invention will now be provided with specific reference to Figures illustrating exemplary embodiments of the invention. It will be appreciated that like structures will be provided with like reference designations.

As discussed in detail below, the orthodontic brackets according to the present invention generally include an orthodontic bracket body and a coating material layered on the surface of the orthodontic bracket body.

I. Exemplary Orthodontic Bracket Bodies

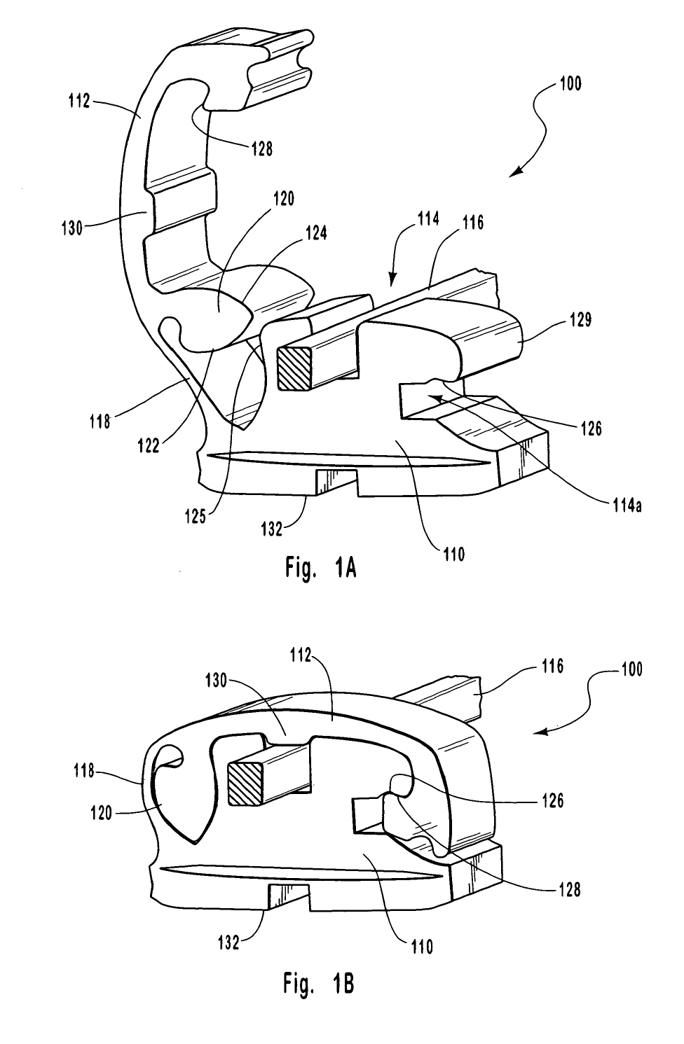

In an exemplary embodiment, the orthodontic bracket body of the present invention is a self-ligating bracket 100, as shown in FIGS. 1A and 1B. Orthodontic bracket 100 has a base 110 to which a cover 112 is hingedly attached. A slot 114 opens to the upper side of base 110, is provided near the center of base 110, and is configured to receive arch wire 116. A second optional arch wire slot 114a can also be provided.

Arch wire 116, is configured to be placed inside slot 114. While arch wire 116 is shown with a square cross-section, any other cross section known in the art can also be used. Tension on arch wire 116 causes slot 114 to align longitudinally with arch wire slot 114 thereby aligning the user's tooth.

Cover 112 is hingedly connected to bracket base 110 by a single elongate film hinge 118. Cover 112 is such that it may be selectively rotated between an open and a closed position relative to arch wire slot 114. Cover 112 maintains arch wire 116 within slot 114 when cover 112 is in the closed, ligating position (FIG. 1B).

In one embodiment, elongate film hinge 118 is designed to bend along substantially its entire length rather than at a single point or line. This feature reduces the risk that the hinge will fatigue or fracture as compared to film hinges that bend along a single line.

The bracket embodiment illustrated in FIGS. 1A and 1B preferably includes an interactive cam structure 120 with a first curved surface 122 and a second curved surface 124. The first curved surface 122 interacts with the elongate film hinge 118 to provide a curved surface that helps ensure that the elongate film hinge 118 bends gradually over its entire length rather than abruptly at any specific location. The second curved surface 122 is curved in such a way so that it interacts with a corresponding wall 125 of the base 110 so as to bias the ligation cover 112 in an open position relative to the bracket base 110 when the ligation cover 112 is in the open position. This improves access to arch wire slot 114, making insertion or removal of the arch wire 116 easier. The second curved surface 124 can, depending on the shape of the corresponding wall 125 of the bracket base 110, also act to bias the ligation cover 112 to remain in a closed position when in the closed position as in FIG. 1B.

An angled keyway 126 is provided near one end of the base 110. The cover 112 contains a corresponding locking tongue 128 that enables the ligation cover 112 to be selectively locked or unlocked relative to the bracket base 110. The ligation cover 112 is locked to bracket base 110 (as shown in FIG. 1B) by closing the cover 112 so that the locking tongue 128 is inserted into angled keyway 126.

Keyway 126 is designed to engage more tightly if arch wire 116 presses against cover 112. In the event that the arch wire 116 pushes against cover 112, rather than causing tongue 128 to withdraw from angled keyway 126, the force causes tongue 128 to more fully enter keyway 126. This mechanism prevents undesired disengagement of cover 112 and increases the safety of orthodontic bracket 100. To open cover, the locking tongue 128 is pulled out of angled keyway 126 and over the outer protrusion 129 of the bracket base 110.

Furthermore, a bearing protrusion 130 is provided at the inside and middle of the cover 112 to assist in fixing the arch wire 116 in the slot 114 while the cover 112 is in the closed position (FIG. 1B). The bearing protrusion 130 reduces the play in the system by effectively widening the ligation cover 112 in the vicinity of the arch wire slot 114. In an exemplary embodiment, bracket 100 is manufactured as a single piece by injection molding a polymeric material.

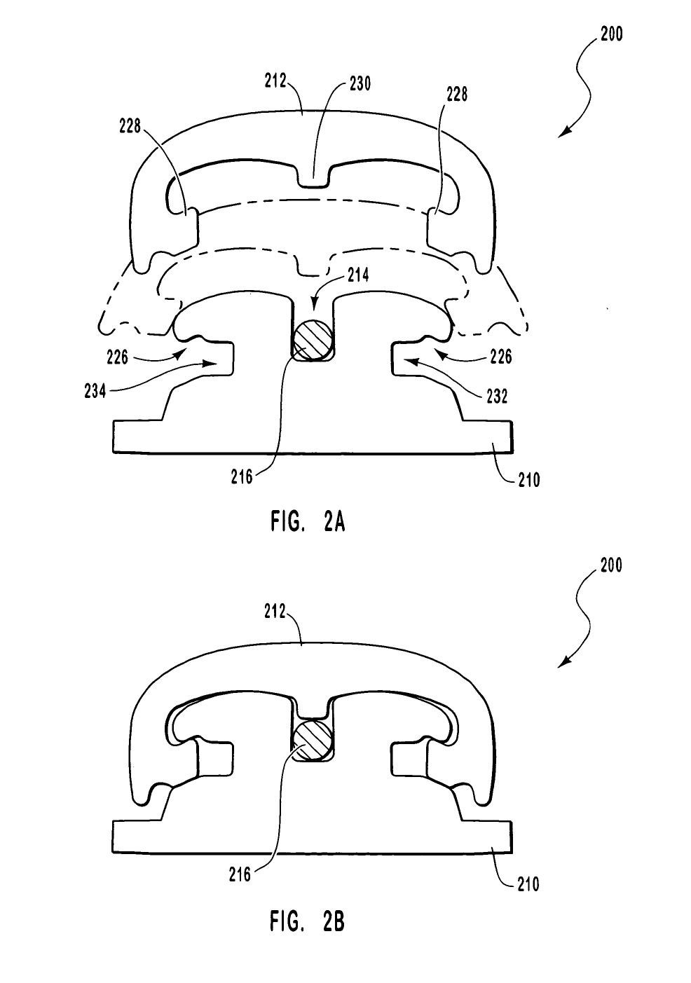

FIGS. 2A and 2B illustrate an alternative bracket that can be coated according to the present invention as described more fully below. Bracket 200 includes a bracket base 210, a ligation cover 212, a slot 214, an arch wire 216, a pair of angled keyways 226, a pair of locking tongues 228, a bearing protrusion 230, and additional arch wire slots 232 and 234. This example differs from those illustrated in FIGS. 1A and 1B in that it includes no hinge between the base 210 and the cover 212. Using the cover 212 results in a self-ligating bracket with a uniform, closed, smooth surface across the top surface of the bracket 200, which is beneficial for patient comfort and hygiene. Both base 210 and ligation cover 212 can be thermoformed using a polymeric material.

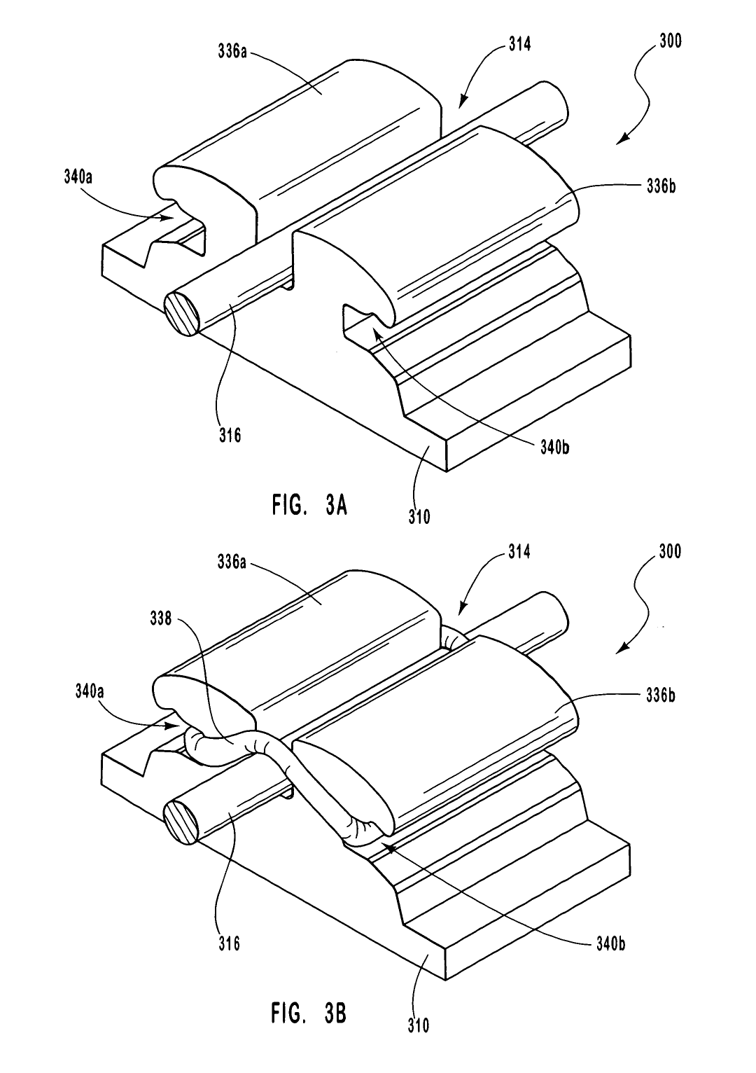

FIGS. 3A and 3B show yet another alternative bracket that can be coated according to the present invention. Bracket 300 includes a bracket base 310, a slot 314, an arch wire 316, and tie wings 336a and 336b. Tie wings 336a and 336b form lateral slots 340a and 340b. As shown in FIG. 3B, elastic band 338 is placed in lateral slots 340a and 340b and over arch wire 316 thereby fastening arch wire 316 in slot 314.

Brackets other than those illustrated in FIGS. 1-3 can be used with the present invention. Those skilled in the art will recognize that there are many different polymeric orthodontic brackets that can be used to make the brackets of the present invention, as well as brackets made from other materials such as metal or ceramic.

The orthodontic brackets described above are formed from a polymeric material. In one embodiment, the polymeric material is a thermoplastic material. Examples of suitable thermoplastic materials include, but are not limited to, polyamides, acetal polymers, polyetherimides, polycarbonates, polyarylether ketones (e.g., PEEK), polysulfones, and polyphenylsulfones.

Crystalline nylons (a type of polyamide) are another class of crystalline polymers suitable for use in forming polymeric orthodontic brackets. A specific example of a crystalline nylon is TROGAMBD, manufactured by Degussa AG, located in Germany. The basic unit of one type of TROGAMID nylon sold under the trade name TROGAMID T is as follows:

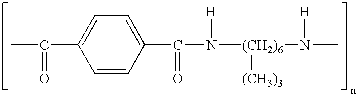

TROGAMID T grade is a specific grade of TROGAMID that is especially useful in forming self-ligating orthodontic brackets according to the invention crystalline polymer.

Another polymeric material useful form forming orthodontic brackets is GRILAMID, manufactured by EMS-CHEMIE AG, located in Germany. Grilamid is a amorphous nylon type polymer available in different grades. GRILAMID TR polymers are transparent thermoplastic polyamides based on aliphatic, cycloaliphatic and aromatic components. The various grades of GRILAMID have different absorption properties in aqueous conditions. GRILAMID also provides surprisingly good toughness and resistance to deformation.

In an exemplary embodiment, the orthodontic brackets of the present invention are formed by injection molding of the thermoplastic material. Where a bracket base and a ligation cover are formed, the bracket base and ligation cover can be formed separately or as a single piece.

In an alternative embodiment, the orthodontic bracket can be made from other materials such as stainless steel or ceramic based materials. Those skilled in the art are familiar with orthodontic brackets made from such materials.

II. Exemplary Protective Coatings

The present invention includes a composite coating material applied to at least a portion of the bracket to create a protective layer. The protective coating layer has particular characteristic that give the coating layer its hardness and abrasive resistant properties. In an exemplary embodiment, the coating material is a composite hybrid of a polymerizable resin and a plurality of organically modified inorganic particles. Generally, the coating material includes at least a type of organically modified inorganic particles, a polymerizable resin, and an initiator for curing the coating composition.

A. Organically Modified Inorganic Particles

The coating material of the present invention includes a plurality of organically modified inorganic particles. In an exemplary embodiment, the organically modified inorganic particles are made in a two step process. First, metal-alkoxides are subject to hydrolysis and polycondensation in a sol-gel process to form particles of a desired composition. In an exemplary embodiment, the particles have a composition according to the formula MxOy, where M=Si, Ti, Zr, or Sn. In a preferred embodiment, the particles comprise a ceramic that includes a plurality of Si atoms. In an exemplary embodiment, the inorganic particles have a diameter of less than about 300 microns. More preferably the diameter of the particles is less than about 1 micron.

In a subsequent step the surface of the inorganic particles are functionalized. Functional groups that can be bonded to the surface of the particles include amines, vinyl groups, acrylates, methacrylates, epoxy groups and combinations of these. In a preferred embodiment, the functional groups include a methacrylate such as bisphenol-A-glycidyldimethacrylate.

In an exemplary embodiment, the functionalized inorganic particles include hydrolyzable and polymerizable silanes with the following formula: 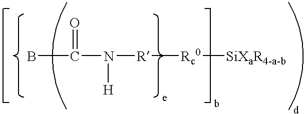
in which the radicals and indices have the following meaning: B=straight-chain or branched substituted or unsubstituted organic radical having 2 to 50 carbon atoms comprising one or more acrylate and/or methacrylate groups, the C(O)N moiety being bonded to a carbon atom of the radical B,;
R=optionally substituted alkyl, alkenyl, aryl, alkylaryl or arylalkyl, each having 1 to 15 carbon atoms, and optionally including oxygen and/or sulfur and/or nitrogen atoms;
R^{o}=optionally substituted alkylene, alkenylene, arylene, alkylenearylene or arylenealkylene, each having 1 to 15 carbon atoms, and optionally including oxygen and/or sulfur and/or nitrogen atoms;
R′=optionally substituted alkylene, alkenylene, arylene, alkylenearylene or aryleneakylene, each having 1 to 15 carbon atoms, and optionally including oxygen and/or sulfur and/or nitrogen atoms;
X=hydrogen, halogen, hydroxyl, alkoxy, acyloxy, alkylcarbonyl, alkoxycarbonyl or NR″₂, where R″ is hydrogen, alkyl or aryl;
a=1, 2 or 3; b=1, 2 or 3, and a+b=2, 3 or 4; c=0 or 1; d=1, 2, 3, 4, 5, 6, 7, 8, 9, or 10; e=1.

Methods of preparing these silanes are disclosed in U.S. Pat. No. 6,794,527 to Wolter et al., issued Sep. 21, 2004, which is incorporated herein by reference. Those skilled in the art will recognize that there are other organically modified inorganic particles that can be used in the polymerizable protective coating materials of the present invention.

The foregoing inorganic particles, functional groups, and specific silanes are examples of particle means for increasing abrasion resistance.

B. Polymerizable Resin

Another component of the coating material is a polymerizable resin, which forms a hybrid or copolymer with the organically modified inorganic particles. The polymerizable resin is selected to bond with the functional groups attached to the surface of the inorganic particles. The resinous material is also selected to bind to the polymeric material of the bracket. Bonding adhesives known in the art can optionally be applied to the surface of polymeric, metal, or ceramic brackets to enhance the bond between the protective coating material and the bracket.

Typically the polymerizable resin can be selected from the same group of polymerizable resins in dental filler or sealer materials. In an exemplary embodiment, the polymerizable resin is an acrylate. In one preferred embodiment, the polymerizable resin is a hydrophic resin such as bisphenol-A-glycidyldimethacrylate and/or urethanedimethacrylate (UDMA). Those skilled in the art are familiar with selecting polymerizable resins that will give the coating material desired properties.

C. Curing System

The curing system is typically selected to work with the polymerizable resin and the functional groups on the inorganic particles. The compositions within the scope of the invention can be photo curable, heat curable, chemically curable, and/or dual curable. In the case of chemical and dual curable coating material, it is typically necessary to provide a two-part (or multi-part) composition that is mixed just prior to use. In the case of a photocurable coating material the polymerizable resin is advantageously stable in the presence of the photoinitiator absent the application of radiant energy. In the case of a heat curable coating material the polymerizable resin is advantageously stable in the presence of the initiator absent the application of sufficient heat.

In the case of a photocurable system, including dual cure systems, irradiating the coating material with radiant energy, such as from an ultraviolet curing lamp, can affect much more rapid curing than chemical cure (or chemical cure alone). The coating layer can typically be photocured in a period of time of about 10 seconds to about one minute.

A commercially available protective coating material suitable for use in the present invention is ADMIRA, which is sold by Voco, Cuxhaven, Germany. ADMIRA uses an organically modified ceramic known by the trademark ORMOCER, which is made available by Fraunhofer ISC in Wurzburg, Germany. Fraunhofer ISC also makes a coating material suitable for use with the present invention known as ORMOCERE. ADMIRA is particularly advantageous because it bonds well due to its inclusion of adhesive resins. Another advantage of ADMIRA is that it is transparent and therefore does not significantly alter the aesthetic properties of the brackets.

III. Applying a Coating Layer

The coating layer can be applied to any desired portion of the surface of an orthodontic bracket to improve the bracket's wear, resistance to deformation, and/or surface properties. Referring again to FIGS. 1A and 1B, in an exemplary embodiment, the entire surface of bracket body 100 has a coating applied thereto. In one embodiment, the bottom portion 132 of base 110 is not coated. By not coating the bottom portion 132, the bracket can more easily be attached to the teeth using known bonding materials and techniques. However, if desired, the entire bracket, including bottom portion 132 of base 110 can be coated with the coating material for ease of manufacturing and/or to improve the bracket's hardness and wear across the entire bracket.

In an alternative embodiment, only certain portions of the surface of the bracket have the coating material applied thereto. In this embodiment, the manufacturer or user selects and applies the coating material to portions of the bracket that are more prone to wear and/or deformation. For example, with some brackets, the cover and/or arch wire slot are more prone to wear and/or deformation and thus only these portions of the bracket can be coated.

Portions of the bracket can also have different amounts of coating material. For example, in one embodiment, the entire bracket or most of the bracket is coated with a single layer. The ligation cover, but not the hinge portion, may be coated an additional 1-3 times. These additional coatings give the cover added hardness and wear resistance, but do not overly coat the hinged portion, which advantageously retains a degree of flexibility to allow the ligation cover to be opened and closed without fracturing.

The orthodontic brackets of the present invention can be coated using one or more of several different techniques. In a first embodiment, an orthodontic bracket is coated with the coating material using a spray coating. In an alternative embodiment, the polymeric orthodontic brackets are coated with coating material using a spin-coating technique. In this embodiment, the orthodontic bracket is immersed in an uncured coating material and then spun to remove excess coating material. Typically, applying the coating material using a spin coating technique is performed by the bracket manufacturer during the manufacturing process.

In yet another alternative embodiment, the coating material is applied to an orthodontic bracket using a brush. In this embodiment, the coating material is brushed on at the desired locations. While not required, the brushing technique is typically performed by the practitioner.

In a preferred embodiment, the coating layer on the surface of the bracket has a preferred thickness in a range of about 0.1 micron to about 100 microns. More preferably, the thickness of the coating layer is between about 0.5 micron to about 5 microns, and most preferably between about 1 micron to about 2 microns.

The coated polymeric brackets of the present invention exhibit surprisingly superior properties over polymeric brackets available in the prior art. Although the coating layer is very thin, the coating layer is able to significantly improve the hardness and flexural stiffness of the bracket. For example, a coating layer on the cover and/or arch wire slot spreads loads over a larger surface area, thereby making the arch wire slot stiffer and more resistant to deformation by forces applied by an arch wire contained therein and/or reducing the flexibility of the cover caused by an arch wire in the slot. The coating layer also adheres very well to polymeric orthodontic brackets, thereby reducing the tendency to crack or delaminate.

Moreover, the surface of the coated bracket has excellent wear properties because it is resistant to abrasive forces. In addition the brackets are better able to resist degradation due to saliva and heat. Surprisingly, these benefits are obtained with a very thin coating layer. Consequently, the coating material can be applied without significantly affecting the shape and/or function of the polymeric bracket.

### EXAMPLE 1

A self-ligating orthodontic bracket was formed by injection molding using a crystalline polyamide (TROGAMID). The bracket was spray coated with a coating material (ORMOCERE) to form a coating layer about 5 microns thick. The coated orthodontic brackets exhibited the following properties under the following test conditions:

| | |
|---|---|
| Test | Measured Value |

Physical Index

| | |
|---|---|
| layer thickness | About 5μ |
| micro hardness¹ substratum | 147 ± 15 M Pa |
| micro hardness coating | 293 ± 12 M Pa |
| abrasion² substratum | 23.9% |
| abrasion coating | 1.9% |
| Adhesion reaction | |
| adhesion initial³ plate | Qt 0 (very good) |
| adhesion initial bracket | Qt 0 (very good) |
| adhesion after cooking test⁴ (plate) | Qt 0 (very good) |
| adhesion after cooking test⁴ (bracket) | Qt 0 (very good) |
| adhesion after storing in artificial saliva (bracket) | Qt 0 (very good) |
| adhesion after test at climate with condensing water | Qt 0 (very good) |
| (bracket) | |
| adhesion after mechanical twisting (bracket) | No cracks or |
| | delaminations |
| adhesion after temperature changing test (bracket) | No cracks or |
| | delaminations |

¹Fischer-universal microhardness (DIN 55676), Indenter: Berkovich-Diamond
²Taber-Abraser-Test (ASTM D 1044); registered is the increasing of the dissemination after 100 rub-cycles
³Grating-cut-test in accordance with ASTM D 3359, Qt = very good, Qt 5 = complete delamination in or outside the grading-cuts
⁴Immersion for 45 min. in cooking, distilled water, 24 h in drying, afterwards grating-cut-test

The coated orthodontic brackets were much more resistant to unwanted deformation, as evidenced by the two fold increase in hardness from about 147 MPa for the uncoated bracket to a hardness of about 293 MPa for the coating, which was a mere 5 microns thick. In a preferred embodiment, the hardness of the cured protective coating layer is preferably greater than about 175 MPa, more preferably greater than about 225 MPa, even more preferably greater than about 250 MPa, and most preferably greater than about 275 MPa.

Furthermore, wear was significantly increased as shown by the decrease in abrasive loss of 23.9% for the uncoated bracket to 1.9% for the coated bracket, as measured by a Taber Abrasion Test according to ASTM standard D-1044. In a preferred embodiment, the cured coating layer decreases abrasion loss to less than about 10%, and more preferably to less than about 5%, as measured by a Taber Abrasion Test according to ASTM standard D-1044.

In addition, the adhesion properties of the coated bracket show that the thin coating layer was able to bond well to the underlying bracket. The coating layer was able to resist degradation from heat, artificial saliva, mechanical twisting and heat cycles.

Whereas applying a protective coating as described herein is especially beneficial in the case of polymeric brackets, the invention is not so limited but extends to applying a protective coating layer to brackets made of other materials, such as metal or ceramic.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An orthodontic bracket that is more resistant to wear and/or deformation, comprising:
an orthodontic bracket body having a surface; and
a protective coating layer on at least a portion of the surface of the orthodontic bracket,
the coating layer comprising a cured polymeric resin chemically bonded to or cross-linked with a plurality of organically modified inorganic particles.

2. An orthodontic bracket as recited in claim 1, wherein the thickness of the protective coating layer is between about 0.1 micron to about 100 microns.

3. An orthodontic bracket as recited in claim 1, wherein the thickness of the protective coating layer is between about 0.5 micron to about 5 microns.

4. An orthodontic bracket as recited in claim 1, wherein the thickness of the protective coating layer is between about 1 micron to about 2 microns.

5. An orthodontic bracket as recited in claim 1, wherein the orthodontic bracket comprises a bracket base having an arch wire slot and a ligation cover, the ligation cover being selectively movable on the bracket base between an open, non-ligating position and a closed, ligating position, and wherein at least a portion of the archwire slot or ligation cover is coated with the protective coating layer.

6. An orthodontic bracket as recited in claim 1, wherein the orthodontic bracket is injection molded from a thermoplastic polymer.

7. An orthodontic bracket as recited in claim 6, wherein the thermoplastic polymer comprises at least one of a polyamide, an acetal polymer, a polyetherimide, a polycarbonate, a polyarylether ketone, a polysulfone, or a polyphenylsulfone.

8. An orthodontic bracket as recited in claim 1, wherein the cured resin comprises an acrylate or methacrylate.

9. An orthodontic bracket as recited in claim 1, wherein the cured resin comprises bisphenol-A-glycidyldimethacrylate or polyurethane.

10. An orthodontic bracket as recited in claim 1, wherein the organically modified inorganic particles comprise a ceramic formed from one or more oxides of Si, Ti, 2r, or Sn.

11. An orthodontic bracket as recited in claim 10, wherein the ceramic particles comprise one or more types of functional groups on the surface thereof selected from the group comprising acrylates, amines, vinyl groups, methacrylates, epoxy groups, hydrolyzable and polymerizable silanes, and combinations thereof.

12. An orthodontic bracket as recited in claim 1, wherein the protective coating layer decreases abrasion loss to less than about 10% as measured by a Taber Abrasion Test according to ASTM standard D-1044.

13. An orthodontic bracket as recited in claim 1, wherein the protective coating layer decreases abrasion loss to less than about 5% as measured by a Taber Abrasion Test according to ASTM standard D-1044.

14. An orthodontic bracket as recited in claim 1, wherein the cured coating layer has a micro-hardness greater than about 175 MPa as measured by the Fischer-universal micro-hardness test (DIN 55676).

15. An orthodontic bracket as recited in claim 1, wherein the cured coating layer has a micro-hardness greater than about 250 MPa as measured by the Fischer-universal micro-hardness test (DIN 55676).

16. An orthodontic bracket that is resistant to wear and/or deformation, comprising:
a bracket base;
at least one arch wire slot formed in the bracket base adapted to receive an arch wire therein;
a ligation cover that can be selectively moved between an open, non-ligating position and a closed, ligating position; and
a protective coating layer on at least a portion of the surface of the orthodontic bracket base or ligation cover,
the coating layer comprising a cured polymeric resin chemically bonded to or cross-linked with a plurality of organically modified ceramic particles.

17. An orthodontic bracket as recited in claim 16, wherein the bracket base and ligation cover are from a polymeric material injection molded as a single piece.

18. An orthodontic bracket as recited in claim 16, wherein the protective coating layer has a micro-hardness greater than about 275 MPa as measured by the Fischer-universal micro-hardness test (DIN 55676).

19. A method of manufacturing an orthodontic bracket having increased resistance to wear and/or deformation, comprising:
providing an orthodontic bracket having a surface;
applying a curable coating material to at least a portion of the bracket surface comprising a polymerizable resin and a plurality of organically modified inorganic particles; and
curing the curable coating material to a protective coating layer having a thickness between about 0.1 micron to about 100 microns.

20. A method as recited in claim 19, wherein the thickness of the coating is between about 0.5 micron to about 5 microns.

21. A method as recited in claim 19, wherein the thickness of the coating is between about 1 micron to about 2 microns.

22. A method as recited in claim 19, wherein the curable coating material is applied by spin coating.

23. A method as recited in claim 19, wherein the curable coating material is applied by brush coating.

24. A method as recited in claim 19, wherein the curable coating material is light cured.

25. A method as recited in claim 19, wherein the curable material is heat or chemical cured.
